(19) United States
(12) Patent Application Publication
(10) Pub. No.: US 2005/0109727 A1
(43) Pub. Date: May 26, 2005

(54) Sonically-ablated sensor

(76) Inventor: Corey A. Salzer, Arvada, CO (US)

Correspondence Address: SETTER OLLILA, LLC, 2060 BROADWAY, SUITE 300, BOULDER, CO, 80302, US

(21) Appl. No.: 10/722,203

(22) Filed: Nov. 25, 2003

(51) Int. Cl. H01B 13/00

(52) U.S. Cl. 216/13; 422/82.01

(57) ABSTRACT

A method of making a sensor to measure an analyte in a solution is disclosed. The method comprises: providing a substrate, printing conductive ink on the substrate to form a plurality of electrode regions, depositing an electrical insulation to cover one of the electrode regions, sonically ablating the electrical insulation to form an array of pores through the electrical insulation to the conductive ink in the one electrode region, and depositing metal into the pores to form an array of electrodes in the one electrode region.

### BACKGROUND OF THE INVENTION

1. Field of the Invention

The invention is related to the field of sensors, and in particular, to sensors that are made using sonic ablation.

2. Statement of the Problem

Some sensors are used to measure an analyte in a solution. For example, a sensor may measure the concentration of chlorine in water. These sensors have a working electrode, a reference electrode, and a counter electrode. The working electrode is made as follows in one example of the prior art. A conductive plate is coated with insulation. The insulation is then sonically ablated to create pores through the insulation to the conducting plate. The pores are then filled with a conducting organic polymer, so the conducting organic polymer contacts the underlying conductive plate. Unfortunately, the conducting organic polymer does not provide the sensitivity that is required to effectively perform many different sensor applications, such as sensing chlorine in water. Conductive organic polymers do not provide the versatility that is required to support numerous different applications.

### SUMMARY OF THE SOLUTION

Some examples of the invention include a method of making a sensor to measure an analyte in a solution. The method comprises: providing a substrate, printing conductive-ink on the substrate to form a plurality of electrode regions, depositing an electrical insulation to cover one of the electrode regions, sonically ablating the electrical insulation to form an array of pores through the electrical insulation to the conductive ink in the one electrode region, and depositing metal into the pores to form an array of electrodes in the one electrode region.

Some examples of the invention include a sensor to measure an analyte in a solution. The sensor comprises: a substrate, a plurality of electrode regions comprising conductive ink printed on the substrate, electrical insulation deposited over one of the electrode regions, an array of electrodes in the one electrode region comprising metal deposited in an array of pores sonically ablated through the electrical insulation to the conductive ink.

In some examples of the invention, the metal comprises gold.

In some examples of the invention, the metal comprises platinum.

In some examples of the invention, the metal comprises chromium.

In some examples of the invention, the metal comprises nickel.

In some examples of the invention, the metal comprises cadmium.

In some examples of the invention, the metal comprises copper.

In some examples of the invention, the metal comprises layers of different metals.

In some examples of the invention, the metal comprises a first layer of chromium and a second layer of gold over the chromium.

In some examples of the invention, the metal comprises a first layer of gold and a second layer of mercury over the gold.

In some examples of the invention, the metal is treated with a chemical solution to modify characteristics of the array of electrodes.

In some examples of the invention, the metal is treated with a thiol solution.

### DESCRIPTION OF THE DRAWINGS

The same reference number represents the same element on all drawings.

FIG. 1 illustrates a method of making a sensor in an example of the invention.

FIG. 2 illustrates a method of making a sensor in an example of the invention.

FIG. 3 illustrates a method of making a sensor in an example of the invention.

FIG. 4 illustrates a method of making a sensor in an example of the invention.

FIG. 5 illustrates a sensor in an example of the invention.

### DETAILED DESCRIPTION OF THE INVENTION

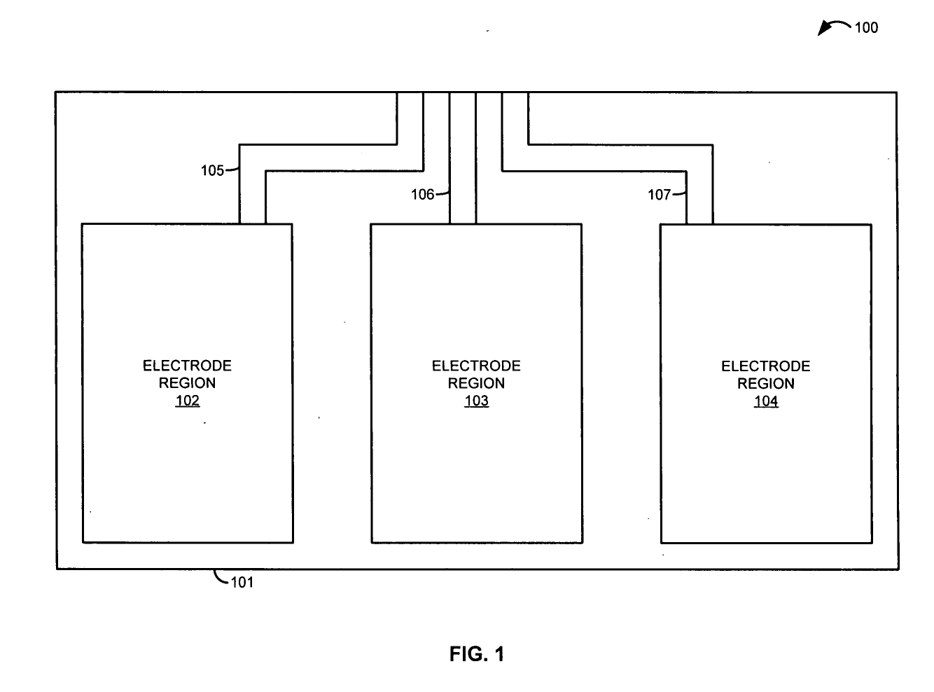

FIGS. 1-5 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their. equivalents.

FIGS. 1-4 illustrate a method of making sensor 100 in an example of the invention. FIGS. 1-4 provide a view from above sensor 100. Note that FIGS. 1-4 are illustrative and do not provide actual dimensions. Sensor 100 is configured to measure an analyte in a solution. For example, the analyte could be chlorine or ferrocene, and the solution could be water.

Referring to FIG. 1, substrate 101 is provided first. Substrate 101 could be plastic, ceramic, glass, or some other suitable material. Conductive ink is then printed on substrate 101 to form electrode regions 102-104 and leads 105-107. The conductive ink could be carbon-based such as graphite, metal-based such as silver, or some other suitable conductive material. Note that the term “printing conductive ink” does not mean that the same conductive ink must be used—the term “printing conductive ink” includes the printing of different inks. Electrode region 102 could be a working electrode, electrode region 103 could be a counter electrode, and electrode region 104 could be a reference electrode.

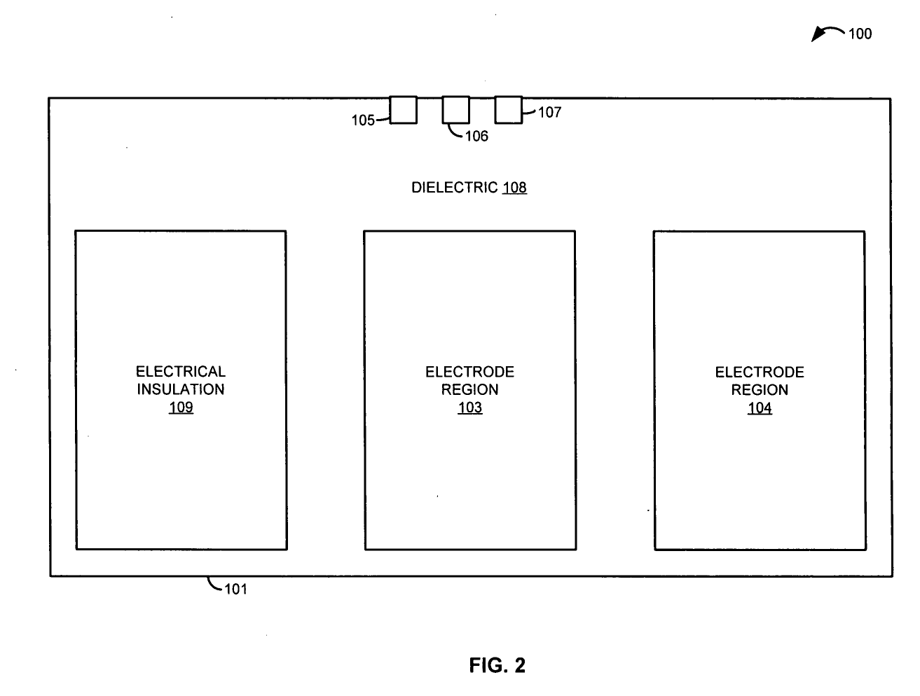

Referring to FIG. 2, dielectric 108 is then placed on substrate 101 to provide a mask. Dielectric 108 typically covers leads 105-107, except for portions of leads 105-107 that form electrical contacts near the edge of substrate 101. Dielectric 108 also typically covers substrate 101 to clearly demark and define electrode regions 102-104.

Electrical insulation 109 is deposited to cover electrode region 102. Electrical insulation 109 could be any material that effectively blocks the flow of electric current.

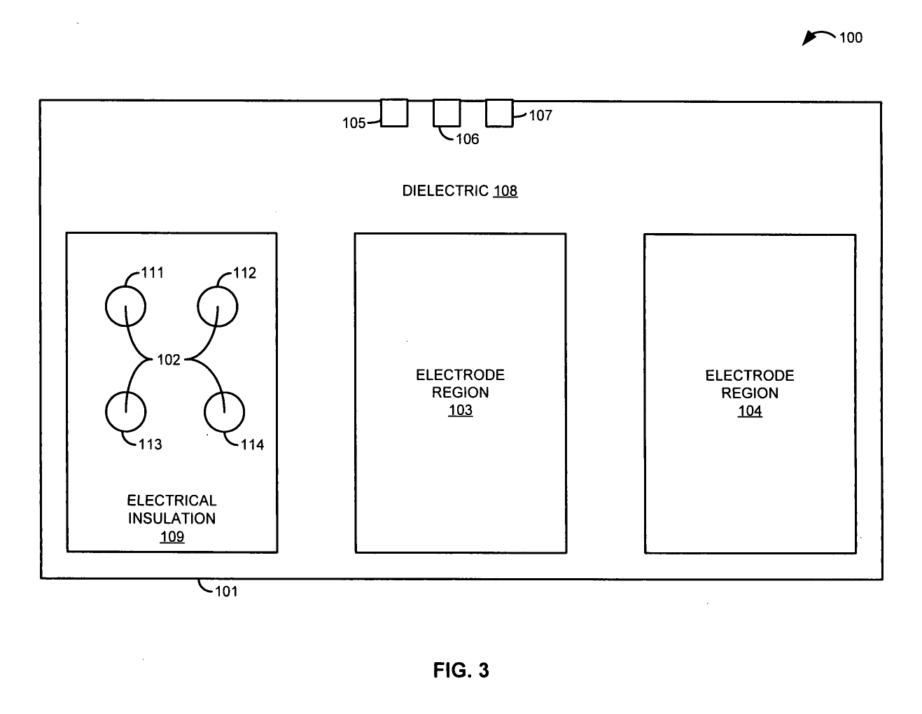

Referring to FIG. 3, electrical insulation 109 is sonically ablated to form an array of pores 111-114. On FIG. 3, the number of pores has been restricted for clarity. A square centimeter of electrical insulation 109 could have between one thousand and one hundred thousand pores. These pores could each have a diameter between 0.1 and 10 microns. The array could have a random placement of pores. An ultra-sonic horn or transducer that sonically induces cavitations in electrical insulation 109 is typically used to perform the sonic ablation. The pores extend through electrical insulation 109 to the conductive ink forming electrode region 102, and thus, pores 111-114 expose electrode region 102.

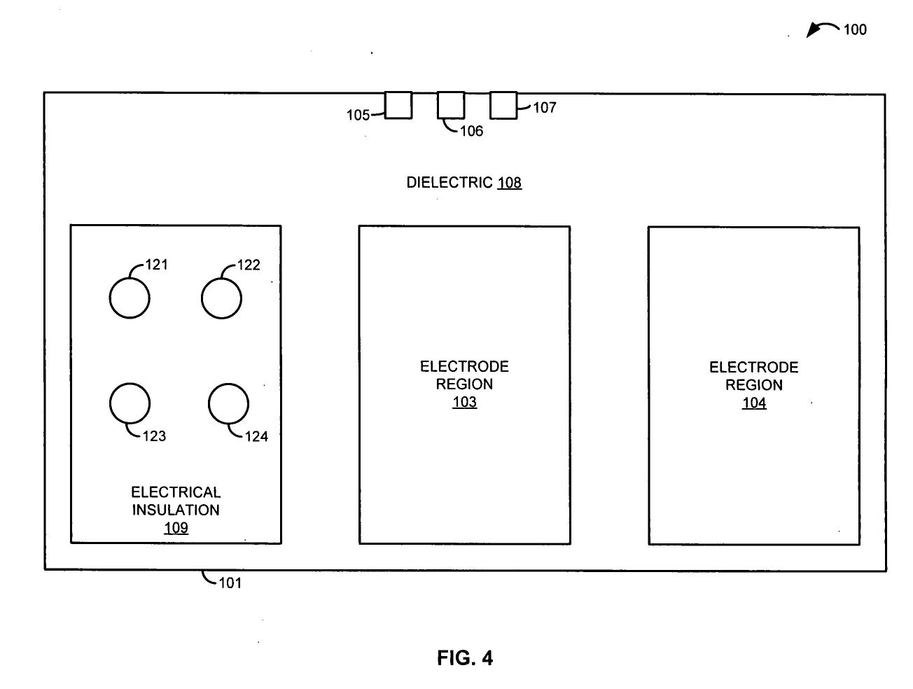

Referring to FIG. 4, metal 121-124 is deposited into pores 111-114 to form an array of electrodes in electrode region 102. The metal may be deposited by placing sensor 100 in a metal-plating solution that has the desired metal dissolved therein. The metal could be gold, silver, platinum, chromium, mercury, nickel, cadmium, copper, or some other suitable metal.

Layers of different metals could be deposited within pores 111-114. For example, a layer of chromium could be deposited in the pores first due to the adhesive properties of chromium, and a layer of gold could be deposited over the chromium. In another example, a layer of gold could be deposited in the pores first, and then a layer of mercury could be deposited over the gold.

In addition, the metal may be chemically treated to modify the characteristics of the electrode array. For example, the metal in the pores could be treated with a thiol solution to improve the electrochemical characteristics on the surface of the metal.

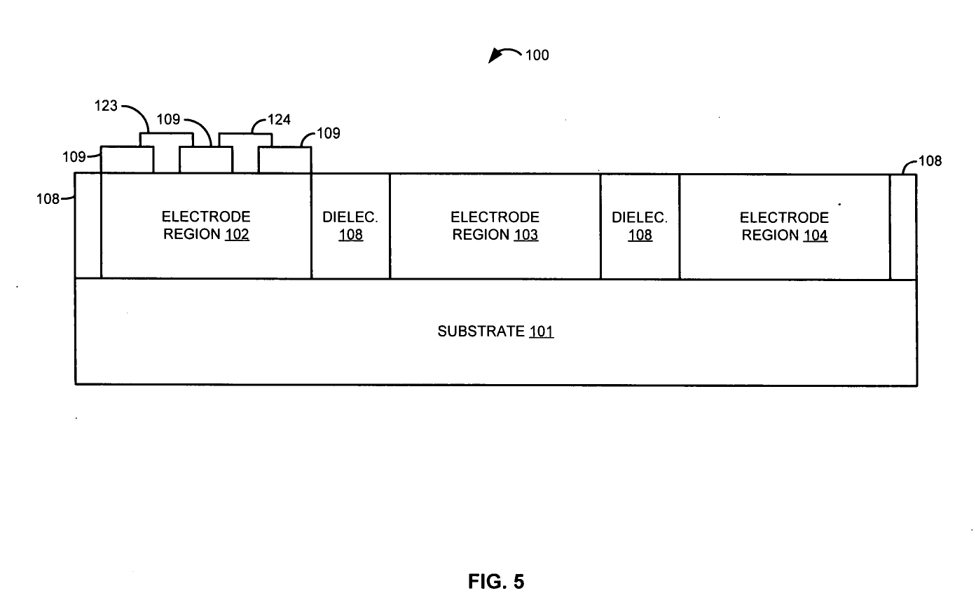

FIG. 5 illustrates sensor 100 in an example of the invention. FIG. 5 illustrates a side view of sensor 100. Substrate 101 forms the base of sensor 100. Electrode regions 102-104 are printed on substrate 101. Dielectric 108 separates and defines electrode regions 102-104 and covers a portion of leads 105-107 (not shown). Electrical insulation 109 covers electrode region 102. To form electrodes 123-124 (electrodes 121-122 are not shown), metal is deposited in pores that were sonically ablated through electrical insulation 109.

In electrode regions 103-104, the conductive ink itself forms the electrodes, such as counter and reference electrodes. In electrode region 102, an array of electrodes is formed by the metal in the pores and the underlying conductive ink. This array of electrodes may comprise a working electrode. If desired there could be many more electrode regions on substrate 101, including additional electrode regions that form electrode arrays.

To detect an analyte in a solution, sensor 100 is placed in the solution. A potential is placed across the working electrode array of region 102 and the reference electrode of region 104. The reference electrode is used in measuring the potential of the working electrode. Electrode region 103 provides the counter electrode to source/sink current. This current is measured at the working electrode, and the current measurement is processed using known techniques to determine the concentration of the analyte in the solution.

The metal in the pores provides better sensitivity than a conducting organic polymer for some applications, such as chlorine detection. The metal in the pores also provides more versatility than a conducting organic polymer to support numerous different applications.

1. A method of making a sensor to measure an analyte in a solution, the method comprising:
providing a substrate;
printing conductive ink on the substrate to form a plurality of electrode regions;
depositing an electrical insulation to cover one of the electrode regions;
sonically ablating the electrical insulation to form an array of pores through the electrical insulation to the conductive ink in the one electrode region; and
depositing metal into the pores to form an array of electrodes in the one electrode region.

2. The method of claim 1 wherein depositing the metal comprises depositing gold.

3. The method of claim 1 wherein depositing the metal comprises depositing platinum.

4. The method of claim 1 wherein depositing the metal comprises depositing chromium.

5. The method of claim 1 wherein depositing the metal comprises depositing nickel.

6. The method of claim 1 wherein depositing the metal comprises depositing cadmium.

7. The method of claim 1 wherein depositing the metal comprises depositing copper.

8. The method of claim 1 wherein depositing the metal comprises depositing layers of different metals.

9. The method of claim 1 wherein depositing the metal comprises depositing a first layer of chromium and a second layer of gold over the chromium.

10. The method of claim 1 wherein depositing the metal comprises depositing a first layer of gold and a second layer of mercury over the gold.

11. The method of claim 1 further comprising treating the metal with a chemical solution to modify characteristics of the array of electrodes.

12. The method of claim 1 further comprising treating the metal with a thiol solution.

13. A sensor to measure an analyte in a solution comprising:
a substrate;
a plurality of electrode regions comprising conductive ink printed on the substrate;
electrical insulation deposited over one of the electrode regions; and
an array of electrodes in the one electrode region comprising metal deposited in an array of pores sonically ablated through the electrical insulation to the conductive ink.

14. The sensor of claim 13 wherein the metal comprises gold.

15. The sensor of claim 13 wherein the metal comprises platinum.

16. The sensor of claim 13 wherein the metal comprises chromium.

17. The sensor of claim 13 wherein the metal comprises nickel.

18. The sensor of claim 13 wherein the metal comprises cadmium.

19. The sensor of claim 13 wherein the metal comprises copper.

20. The sensor of claim 13 wherein the metal comprises layers of different metals.

21. The sensor of claim 13 wherein the metal comprises a first layer of chromium and a second layer of gold over the chromium.

22. The sensor of claim 13 wherein the metal comprises a first layer of gold and a second layer of mercury over the gold.

23. The sensor of claim 13 wherein the metal is treated with a chemical solution to modify characteristics of the array of electrodes.

24. The sensor of claim 13 wherein the metal is treated with a with a thiol solution.
